(19) United States
(12) Patent Application Publication
(10) Pub. No.: US 2004/0172290 A1
(43) Pub. Date: Sep. 2, 2004

(54) Health monitoring device

(76) Inventor: Samuel Leven, Loxahatchee Groves, FL (US)

Correspondence Address: AKERMAN SENTERFITT, P.O. BOX 3188, WEST PALM BEACH, FL, 33402-3188, US

(21) Appl. No.: 10/620,012

(22) Filed: Jul. 15, 2003

Related U.S. Application Data
(60) Provisional application No. 60/395,985, filed on Jul. 15, 2002.

(51) Int. Cl. G06F 17/60

(52) U.S. Cl. 705/2

(57) ABSTRACT

A wearable health monitoring device includes a plurality of sensors configured to monitor health indicators, one or more memory communicably coupled to the sensors for storing detected health indicators as data, a transceiver communicably coupled to the sensors for wireless communications configured for transmitting and receiving data, one or more medication delivery systems for administering substances to a patient, and a processor configured to dynamically regulate substance delivery to the patient where the processor is responsive to indicator data. Also, a method for monitoring the health indicators of a patient includes storing an individualized patient profile to establish normal ranges of health indicators, detecting patient health indicators, comparing detected health indicators to the patient profile, and initiating a programmatic response to one or more of the detecting step and the comparing step.

### CROSS REFERENCE TO RELATED APPLICATION

Under 35 U.S.C. §119(e), this application claims the benefit of U.S. Provisional Application No. 60/395,985 entitled Health Monitoring Device, filed on Jul. 15, 2002, the entirety of which is now incorporated herein by reference.

### BACKGROUND OF THE INVENTION

1. Technical Field

This invention relates generally to the field of medical devices, and more particularly, to wearable health monitoring and medication delivery and control devices.

2. Description of the Related Art

Several attempts have been made to develop an apparatus that provides efficient and reliable health monitoring capabilities. For instance, a number of inventions in the prior art have incorporated the use of devices to monitor medical conditions of bodily organs, such as the heart. Specifically, in U.S. Pat. Pub. No. 2002/0016719 to Nemeth et al. (“Nemeth”), a medical device is disclosed which includes a wireless communication device to receive medical data from a monitor borne by an ambulatory patient and wirelessly transmits at least some of the medical data to a computer network. Nevertheless, the device disclosed in Nemeth fails to provide immediate and individualized health monitoring to a user.

Although some health monitoring devices can collect important health data, such devices do not adequately address how the information is to be provided to necessary personnel and/or healthcare systems in a timely manner. Moreover, such devices do not provide a means for treating any detected health indicators. That is, the collection of data alone neither addresses patient needs with respect to notifying proper healthcare personnel of an impending health crisis, nor addresses the crisis itself. Ensuring that collected data is provided to proper healthcare personnel can be time critical. The slightest delay in transmission can result in severe bodily harm or death to the patient.

Additionally, many health monitoring devices are not suitable for monitoring the ambulatory patient in a real world environment. Instead, many health monitoring systems are complex, stationary systems typically located within healthcare facilities. Accordingly, patients must remain within a healthcare facility, confined to a relatively small area, to access to the necessary health monitoring equipment. Although healthcare personnel are readily available for treating health indicators, staying in a healthcare facility for a prolonged period of time to monitor health indicators can be extremely costly and can produce emotional strain. Furthermore, a healthcare facility provides a controlled environment, in which any patient monitoring may be skewed in consequence of removing the patient from a real world environment and collecting data from the patient in this controlled environment.

With regard to treatment, many patients routinely take medications to treat and regulate newly detected and existing health indicators. While many patients continue to orally ingest medications or receive injections, many others have chosen to have medication pumps implanted subcutaneously. Implantation of a medication pump ensures that the patient receives a constant flow of medication or a periodic dose of medication according to the programming of the medication pump. Conventional medication pumps, however, are programmed by a physician during routine visits to the physician's office. As the programming of the medication pump cannot be altered without a physician and a physician operated programming device, the medication pump is incapable of dynamically adapting to patient needs.

### SUMMARY OF INVENTION

The invention disclosed herein provides a device, system and method for monitoring various health related functions as well as for controlling medication delivery systems. In particular, the present invention can monitor selected health indicators using a plurality of sensors. Health indicator data can be collected, stored, and transmitted to various parties. As used herein, health indicator data can include any data collected from the various sensors disclosed herein, as well as any operational data with respect to the health monitoring device itself, or other systems under control of the health monitoring device such as medication delivery systems. Additionally, the health indicator data can be transferred to a remote site for use by a healthcare provider or the like.

According to the invention, a wearable health monitoring device includes a plurality of sensors configured to monitor health indicators, at least one sensor interface for receiving health indicator data from the plurality of sensors, at least one memory for storing the health indicator data, and a processor for analyzing the health indicator data. The processor can be configured to dynamically regulate a substance delivery mechanism responsive to the health indicator data. The sensors can include a sensor to monitor heart rate, heart murmurs, heart intensity, electro-cardio signals, lung noise, respiration rate, occlusion, adrenal level, acetycholine level, temperature, and sodium levels.

In one embodiment, the health monitoring device can include a wireless transceiver for communicating with at least one of an emergency service, a health care professional, a third party, and a processing device. The wireless transceiver further can be configured to detect available communication links. The monitoring device can include a viewing screen for displaying one or more of data from the sensors, data received by the transceiver, and device diagnostic information.

The processor of the health monitoring device can be programmed with an individualized patient profile establishing ranges of normal health indicators where the processor compares detected health indicators with the patient profile. The processor can signal the medication delivery system to regulate the delivery of at least one substance. Notably, the processor can signal the medication delivery system via a wireless transceiver.

The medication delivery system can include one or more of a dermal patch, a medication port, and a medication pump. The monitoring device further can include a wireless transceiver for communicating with an authorized computing system, wherein the processor signals the medication delivery system to regulate the delivery of a substance responsive to receiving a medication delivery signal fro the authorized computing system.

Another embodiment of the present invention can include a patient health monitoring system. The patient health monitoring system includes a wearable patient health monitoring device, one or more health professional computing devices communicably coupled to the health monitoring device via a communications network, and one or more third party computing devices communicably coupled to the monitoring device via a communications network. The patient monitoring system can also include a patient computing device communicably coupled to the monitoring device and communicably coupled to the health professional computing device and the third party computing device via at least a wired communications network and/or a wireless communications network.

In one arrangement, the patient computing device and/or the health monitoring device can be configured to play audible messages. Additionally, the health monitoring device can include a processor operatively connected to the sensors. The processor can be programmed with an individualized patient profile establishing ranges of normal health indicators where the processor compares detected health indicators to the range of normal health indicators. The monitoring device can also signal one or more of the patient computing device, the health professional computing device, and the third party computing device when detected health indicators are outside of the range of normal health indicators. The patient profile can be updated based on detected health indicators and the monitoring device can contact one or more of the health professional computing device and the third party computing device based on data from the sensors.

In accordance with the inventive arrangements, a method for monitoring the health indicators of a patient includes storing an individualized patient profile to establish normal ranges of health indicators, detecting patient health indicators using at least one sensor, and comparing detected health indicators to the patient profile. The method also includes initiating a programmatic response to one or more of the detecting step and the comparing step where the programmatic response is selected from the group consisting of notifying a health professional, notifying the patient, notifying a third party, and regulating the delivery of a substance to the patient. The method can also include the step of signaling at least one of a personal computing device, a third party computing device, and a health professional computing device when the detected health indicators are outside of the established normal range.

In one embodiment, the method can include the step of storing at least one prerecorded message and playing at least one prerecorded message. The method can include the steps of receiving a communication from a remote computing system specifying a suggested course of treatment. Accordingly, a medication delivery system can be signaled to regulate the delivery of at least one substance according to the suggested course of treatment. The method can also include the step of updating the patient profile according to detected health indicators.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a schematic diagram illustrating a health monitoring and medication delivery control device in accordance with the inventive arrangements disclosed herein.

FIG. 2 is a schematic diagram illustrating a health monitoring system for the collection and transfer of health indicator data through a communications network using the health monitoring device of FIG. 1.

FIG. 3 is a flow chart illustrating steps of one embodiment of a method for monitoring health indicators of a patient in accordance with the inventive arrangements.

### DETAILED DESCRIPTION OF THE INVENTION

The invention disclosed herein provides a wearable health monitoring device, system, and method of using the same. Specifically, the present invention can monitor a user's heart condition as well as additional health indicators and/or vital signs. Accordingly, the present invention provides a health monitoring system for collecting and storing data relating to the various health indicators disclosed herein. Additionally, the present invention provides a health monitoring device, system, and method that can also be used in the course of treatment. Generally, health indicators are any measurable presence and/or level of particular substances, rates, or conditions which can affect an individual's health. The health indicator data which is collected by the health monitoring device can be made available to the user and/or other authorized third parties. The health indicator data can be transferred via a wired connection and/or a wireless connection. Accordingly, a heath care provider, such as a doctor, can access the health indicator data to provide additional and continuous monitoring of a user's health. Notably, the present invention also can control one or more medication delivery systems responsive to measurements from the sensors. As a result, the flow of medication can be dynamically controlled responsive to measurements taken from one or more of the sensors to be described herein.

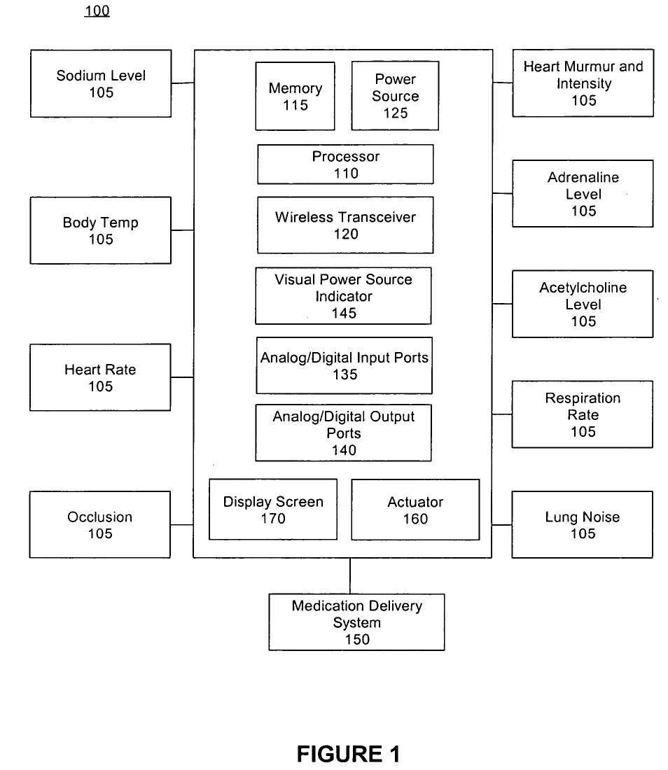

FIG. 1 is a schematic diagram illustrating an exemplary health monitoring device 100 in accordance with the inventive arrangements disclosed herein. As shown in FIG. 1, a wearable health monitoring device 100 can include a plurality of sensors 105, a processor 110, one or more memories 115, a power source 125, a wireless transceiver 120, analog/digital input ports 135, analog/digital output ports 140, and one or more medication delivery systems 150. The aforementioned components can be communicatively linked via suitable circuitry and/or wireless communication links as disclosed herein. For example, the processor 110, memory 115, and input/output sections of the health monitoring device 100 can be communicatively linked via a communications bus.

The power source 125 enables the health monitoring device 100 to operate for extended periods of time with little maintenance. The power source 125 can include a lithium battery or other rechargeable power supply. The health monitoring device 100 also can include a visual power source indicator 145 to operate as a signaling device to indicate that the power source 125 is operational. For instance, the visual power source indicator 145 can be in the form of a red light visible from the surface of the device 100. Additionally, the visual power source indicator 145 can display multiple colors and can display a blinking or flashing light to indicate the power level of the power source 125. Such an arrangement can provide the user ample warning to recharge the health monitoring device 100 before the power source 125 is depleted. Regardless, the unit can be charged using a conventional electrical adapter and/or cradle unit. Notably, the cradle unit can provide an addition means for sending and receiving information to and from computer systems and/or updating the operational software of the health monitoring device 100. Furthermore, the health monitoring device 100 can be completely operative when charging so that there are no time periods when the patient is not being monitored.

The plurality of sensors 105 can monitor various vital signs. The sensors 105 can provide for the monitoring of heart rate, murmur and intensity, lung noise, as well as respiration rate and occlusion. Additionally, the health monitoring device 100 can include sensors 105 for measuring adrenaline level and the acetylcholine level in one's perspiration. The health monitoring device 100 also can include sensors 105 for monitoring body temperature, sodium levels, and electro-cardio signals. The sensors 105 can be commercially available active and/or passive sensors, including chemical sensors or dermal patches, for measuring the various health indicators previously mentioned. Notably, additional sensors 105 can be included for measuring levels of particular chemicals and/or medications within a user's body. The sensors 105 can be affixed to a user's body or can be located subcutaneously. According to one embodiment of the present invention, the sensors 105 can include micro-sensors, biodegradable micro sensors, or other sensors produced using micro-machine technology.

As shown in FIG. 1, the various sensors 105 can be communicatively linked to the health monitoring device 100 via a series of analog and/or digital input ports 135. The sensors 105 can be identified by the health monitoring device 100 by the port through which a sensor is connected, or alternatively, via an identifying signal sent from the sensor prior to sending relevant health indicator data. The identifying signal signifies to the health monitoring device 100 which sensor is sending health indicator data. Notably, if the sensors are able to communicate via wireless means, for example via radio frequencies (RF), sound waves, and/or infrared technology, data can be received from the various sensors 105 via the wireless transceiver 120. Sensors 105 further can send identifying signals indicating that the sensor 105 is associated with a particular health monitoring device 100 to prevent the health monitoring device 100 from detecting and reacting to wireless sensor signals from another health monitoring device. Although the sensors 105 are depicted as being located outside the casing of the health monitoring device 100, those skilled in the art will recognize that one or more of the sensors 105 can be disposed within the health monitoring device 100.

Health indicator data received from the sensors 105 can be stored in memory 115 for later retrieval via wired or wireless transmission. According to another embodiment, memory 115 can be physically removed from the health monitoring device 100 to allow for the retrieval of health indicator data in the event of loss of power and/or malfunction of the health monitoring device 100. In addition to health indicator data, a patient's medical history can also be stored in memory 115. Notably, if the health monitoring device 100 receives digital signals from one or more sensors 105, the digital data can be provided to the processor 110 via the wireless transceiver 120 and/or the digital input ports 135. The processor 110 can sort the data and store the health indicator data within the memory 115. In the event that analog data is received from one or more sensors 105, the analog data can be received bythe wireless transceiver 120 and/or the analog input ports 135. Notably, the processor 110 can include one or more inputs having analog-to-digital converters for converting the received health indicator data into digital format. Accordingly, once converted, the health indicator data can be stored in the memory 115.

The wireless transceiver 120 can perform several functions. In particular, the wireless transceiver 120 can be used to communicate with one or more other computer systems. For example, the wireless transceiver 120 can be Blue Tooth-enabled or use some other short range wireless protocol, such as the 802.11 series of wireless protocols. The wireless transceiver 120 further can be used to communicate with one or more of the sensors 105 and/or the medication delivery system 150. For example, via the wireless transceiver 120, the processor 110 can control various sensors 105 and the medication delivery system 150, as well as receive information from the sensors 105 and the medication delivery system 150. Still, the wireless transceiver 120 can include a cellular communications unit capable of initiating telephone calls, a paging unit, a text messaging unit, or other wireless electronic messaging system. Notably, the analog/digital input ports 135 and analog/digital output ports 140 also can provide a means for the health monitoring device 100 to communicate with one or more external computers as well as the sensors 105 and medication delivery system 150. The memory 115, as mentioned, can be used to store health indicator information. Additionally, the memory 115 can include any data, applications, and/or logic which may be required by the processor 110 to process data and handle input/output functions of the health monitoring device 100. The processor 110 also can include internal memory in which data, applications, and/or logic can be stored for instructing the processor 110 on performing data processing and the various input/output functions described herein.

In one embodiment, the health monitoring device can include an actuator 160. The actuator can include any suitable input means, such as a button or switch, that can be activated by the user. Activating the actuator 160 can initiate an emergency call to a health care professional, a third party, and/or emergency services, such as 911.

Similar to the various sensors 105, the medication delivery system 150 can be communicatively linked to the health monitoring device 100 via a wired and/or wireless connection. For example, the medication delivery system 150 can receive instructions from the health monitoring device 100 via the wireless transceiver 120 and/or the analog/digital output ports 140. The medication delivery system 150 further can provide information to the health monitoring system 100 via the wireless transceiver 120 and/or the analog/digital input ports 135. In any case, the medication delivery system 150 can be controlled by the health monitoring device 100. Furthermore, because the health monitoring device 100 can receive wireless communications from a health professional, the health professional can provide instructions to the processor 110 to control the medication delivery system 150. Thus, a health care professional can provide remotely initiated medication delivery.

In another arrangement, the health monitoring device 160 can wirelessly communicate with an external medication delivery system (not shown). While some medications can be delivered via pumps or patches, delivery systems for other medications still require manual manipulation of the medication. For example, many individuals must take daily insulin shots that can sometimes vary in dosages. The monitoring device can communicate to a external insulin delivery system to ensure the proper dose of insulin is provided in a syringe, a task that may be difficult for an aging patient with failing eyesight.

In operation, the,health monitoring device 100 can receive health indicator data front the various sensors 105. The processor 110 can execute a program configured to collect health indicator data from the various sensors and store the information within the memory 115. Notably, the processor 110 can be configured to compare health indicator data received from the sensors 105 with a user profile, also stored in memory 115. The user profile can be initially programmed or can be established over a period of time by monitoring the patient. The user profile can include ranges of different hormone levels, average heart rate, average respiration rate, and the like. The patient profile can also include medical history, those substances to which the patient is allergic, current medication being taken and/or subscribed to the patient, and important timing information, such as the time and date of last medication delivery for a particular substance. Thus, any detection of bodily conditions that are outside of the normal ranges can indicate a potential health problem.

The user profile can be dynamically updated over time as a patient's normal ranges of health indicators may change with age, weight gain or loss, exercise habits and the like. Accordingly, the health monitoring device 100 can note particular vital signs, health indicators, and health trends, measurement averages, and any deviations of the collected health indicator information from the user profile. Responsive to measurements taken from the sensors 105 and calculations performed by the processor 110, the processor 1 10 can instruct the medication delivery system 150 to supply more or less medication to the user as the case may be. The medication delivery system disclosed herein can include controllable dermal patches, as well as more complex medication pumps.

For example, several varieties of medication pumps, whether located on the exterior of one's body or intended to be subcutaneously located, can be controlled via a control unit such as the health monitoring device 100 through a wired or RF communications link. Medtronic Inc. of Minneapolis Minnesota manufactures one or more subcutaneous medication delivery systems which can be controlled via an RF communications link. Still, other medication delivery systems can be controlled by the health monitor system 100. For example, micro injection medication pumps and/or micro injection and infusion equipment can be used with the present invention. Regardless of the variety of medication pump used, it should be appreciated that the present invention provides for the dynamic control of the medication delivery system 150 responsive to health indicators as measured and detected by the health monitoring device 100.

In one embodiment, the health monitoring device 100 can include a display screen 170. The display screen 170 can allow the patient and/or a health professional to directly review the detected health indicator data without first transmitting the health indicator data. Such a display screen 170 may be greatly beneficial in an emergency context, such as when a paramedic treats a patient, or in other cases where there is no device readily available for receiving and reviewing transmitted health indicator data. Additionally, a display screen 170 can be used to display diagnostic information regarding the health monitoring device 100 and can also be used to display information received by the wireless transceiver 120, such as directions from a health care professional. The information displayed by the display screen 170 can be navigated in any standard interface that is well known in the art, such as via touch screen technology, navigational buttons (not shown), a scroll wheel (not shown), and the like.

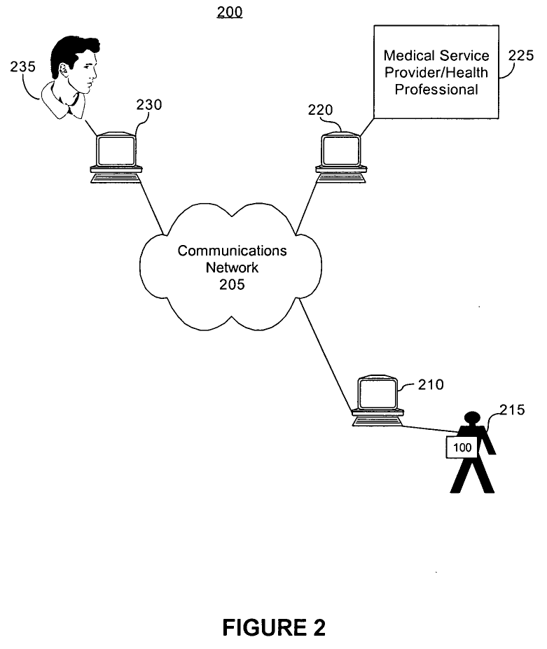

FIG. 2 is a schematic diagram illustrating a health monitoring system for the collection and transfer of health indicator data using the health monitoring device of FIG. 1. The health monitoring system 200 includes a health monitoring device 100, a computer communications network 205, a user computer system 210 and one or more additional computer systems providing access to a medical service provider/health professional 225, such as a doctor, and third party 235, such as an insurance agency, friends, relatives, or other authorized party. The computer communications network 205, can include, for example, the Internet, the Public Switched Telephone Network (PSTN), Local Area Networks (LAN), Wide Area Networks (WAN), and the like. Accordingly, through the computer communications network 205, stored data can be transferred or uploaded from the user's computer system 210 to a network connected computer system for access by the user 215, a designated doctor 225, or other authorized third party 235. For example, health indicator data can be accessed via a Web site through a visual and/or audio (voice) browser. Data received from third parties also can be downloaded and/or accessed from the user's computer system 210 and/or the health monitoring device 100. Additionally, collected health indicator data can be transferred freely to a third party computer system 230 and a doctor's computer system 220 for further detailed analysis.

In operation, a health. monitoring device 100 can be strapped to one's chest or worn around the neck. As the user computer system 210 can include wireless communications means, the health monitoring device 100 can be communicatively linked to the user computer system 210 via a wireless and/or wired communications link. Accordingly, the health monitoring device 100 can send collected heath indicator data and medication delivery system control data to the user computer system 210 and receive programmatic instructions from the user computer system 210. The user computer system 210 can store data for several weeks and transmit data to one or more other computer systems via a wireless and/or wired communications link.

As illustrated in FIG. 2, the present invention can include a conventional home computer system 210 equipped with suitable software. The computer system 210 can be utilized to store health indicator data continuously, to offload the health indicator data from the health monitoring device 100 when the memory is full, or when the remaining battery power of the health monitoring device 100 has been depleted to a predetermined level, in which case the health indicator device 100 can enter a power save mode until the health indicator data is retrieved manually.

Notably, in the event the memory fills, the health indicator device 100 can operate in different and selectable modes. In one mode, the health monitoring device 100 can cease collecting health indicator data to preserve health indicator data already collected. In another mode, health indicator data can be continuously overwritten. If the processor is equipped with suitable monitoring software, another mode allows the health monitoring device 100 to preserve any health indicator data specifying any anomalous or otherwise problematic results. For example, a user profile specifying ranges of normalcy for the monitored health indicators can be stored in memory. Any detected health indicators falling outside the predetermined ranges can be securely stored so as not to be overwritten. In still another mode, the detected health indicators can be transferred in real-time to the user computer 210 so that the detected health indicators are not stored in memory 115 within the health monitoring device 100, but are stored in the memory of the user computer 210. Notably, the modes can be both selected by the user and automatically selected by the health monitoring device 100.

The health indicator data, depending upon user preference, can be transmitted continuously in real time, at predetermined intervals, or responsive to a user 215 request. For example, a user 215 experiencing any noticeable changes in pulse rate or other symptoms indicating possible health problems, can instantly transmit health indicator data to his doctor 225 by depressing an actuator located on the health monitoring device 100. A panic button can be integrated with or separate from an actuator and can provide the latest health indicator data available to one or more predetermined network addresses. Similarly, the health monitoring device 100 can initiate 911 calls or other calls to preprogrammed numbers. For example, the health monitoring device 100 can place a wireless telephone call or instruct the computer system 210 to place a telephone call via a modem communicatively linked to the computer system 210. The health monitoring device 100 further can include audio capability to play prerecorded messages in the event the user 215 is incapacitated When a communication link is established. Similarly, a user 215 can transmit data to the doctor 225 in intervals, or from time to time, providing the doctor 225 with the ability to monitor the user's 215 corresponding vital signs without the user 215 being located in the doctor's 225 office.

According to one aspect of the present invention, an operative wireless communications link can be detected automatically. In the event such a link is detected and a connection is made, the present invention can transmit the collected health indicator data to a remotely located computer system, which is accessible through the wireless communications link. The data can be transmitted with a unique identifier corresponding to the user's 215 identity. Once the data is transmitted, the data can be processed, whether in the home of the user 215 on a local computer 210, or on a remotely located computer, such as computer 230 and/or computer 220, by software configured to detect particular health indicators through analysis of the collected data through comparison with reference models and/or user profiles. If necessary, the software can send electronic alerts to the user's doctor 225. The health indicator data also can be processed in a server communicatively linked to the computer communications network 205 and made available through a Web site for user and/or doctor review. Advantageously, the invention allows health indicator data to be collected over a period of weeks thereby facilitating the early detection of heart attack through the analysis of health indicators collected over an extended period of time.

According to another aspect of the invention, the doctor 225 can be prompted or notified of any impending bodily changes. For example, the collected health indicator data can be provided to a user's doctor 225 to place the doctor 225 on alert. Subsequently, the doctor 225 can proceed with any steps necessary to prevent and treat a detected health condition. For instance, the health monitoring device 100 can detect an increased heart rate of a user 215, notify a doctor 225, and also provide relevant health indicator data to the doctor 225. Upon receipt of such information, the doctor 225 may administer preventative medication and develop medical treatment.

For example, physicians and/or third party medical service providers 225 can make medical treatment recommendations which can be transmitted to the user's computer 210 or to the health monitoring device 100 directly. Thus, the health monitoring device's 100 display screen 170 can be used to view data collected by the monitor's sensors, received information from the computer communications network 205, and/or other health monitoring device 100 diagnostic information. Notably, the medical service providers 225 can initiate instructions and/or program changes which can be uploaded to the health monitoring device 100. Accordingly, a physician or other qualified and authorized medical service provider can alter the programming of the health monitoring device 100 to instruct any medication delivery systems 150 under the control of the health monitoring device 100 to increase and/or decrease the delivery rate of one or more medications to the user. The data relating to the user's 215 vital signs also can be utilized to prepare an early diagnosis in the instance of an emergency situation before a doctor 225 has physically examined the user.

Similarly, the invention disclosed herein can be used to transfer health monitor data concerning the user's 215 vital signs to an authorized third party 235. As illustrated in FIG. 2, the data can be transferred to a third party, such as a family member or the like, to provide the designated third party 235 with important information regarding the user's 215 health condition. For instance, a third party 235, such as an adult child of an aging parent, can utilize the computer system 230 to receive health indicator data as well as diagnostic and treatment related information from medical service providers 225. Thus, authorized third parties can receive constant information regarding a particular user's 215 health during specific intervals or other selected time periods. It should be appreciated, however, that access to the health indicator data and medical diagnostic information can be protected through the use of passwords, encryption, and/or authentication techniques to ensure that access to sensitive medical information is limited to authorized users only.

The present invention also can include a health monitoring device 100 having chemical sensors to monitor the effect and delivery of medication to a user 215. For example, chemical sensors in the form of dermal patches can be used to administer medication and detect levels of medication within the user 215. Accordingly, the health monitoring device 100 can be used to regulate the delivery of medication, whether delivered through a dermal patch or other medication delivery system as previously described, to the user 215.

In one arrangement, the detected health indicators can be continuously compared to normal ranges and/or conditions as set forth in a user profile. Any detected health indicators that are outside of the normal ranges and/or conditions can indicate that a potential health problem exists. Furthermore, constant comparison can detect the early signs of health problems that are generally not noticeable or simply ignored as an uncomfortable feeling. In particular, the health monitoring device 100 can detect the electrical dysfunction often associated with and preceding a heart attack. Such early detection can allow the health monitoring device 100 to administer the appropriate medicine to completely stop a heart attack and/or notify any combination of the user, a health care professional, and a third party to give advanced warning so that the user can seek and/or receive emergency health care.

In another example, a chemical sensor can deliver medication to increase a user's 215 heart rate upon receipt of data indicating the user's 215 heart rate has declined below a predetermined range. Conversely, a chemical sensor can deliver medication to decrease a user's 215 heart rate upon receipt of data indicating the user's 215 heart rate has exceeded a predetermined range. The health monitoring device 100 can monitor and deliver medication through a series of dermal patches and/or medication pumps operatively connected to the health monitoring device 100. For example, medication levels can be monitored through one dermal patch and the delivery of medication can be regulated through another dermal patch and/or a medication port or pump.

The wireless connectivity of the present invention can support additional emergency functions. For example, healthcare facilities such as emergency rooms and the like, can be equipped with wireless communication equipment for communicating with the health monitoring device 100. Thus, if a user is brought into such a facility, the health monitoring device 100 can detect a wireless network connection and upload any collected health indicator data to the healthcare facility computer system so that the user may be readily diagnosed. Similarly, when traveling, various establishments can be equipped with wireless communication equipment allowing the health monitoring device 100 to automatically detect a network connection and upload data that can be sent to any one of a variety of network addresses including, but not limited to, the user's computer system 210 and third party computer systems 220 and 230. Thus, data can be archived and/or analyzed without the user having to be in close proximity to the user's home computer 210.

Still, as previously mentioned, the health monitoring device 100 can be programmed to process received health indicator data and identify particular medical conditions as determined form the collected health indicator data and store/update the patient profile. Accordingly, the health monitoring device 100 can dynamically control one or more medication delivery systems 150 responsive to a user's detected health indicators.

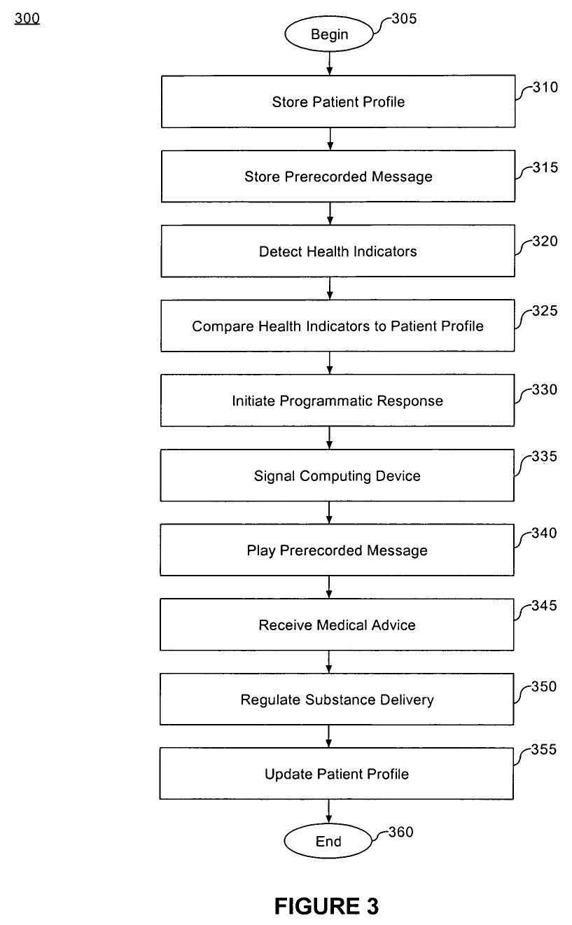

Also in accordance with the inventive arrangements, a method 300 for monitoring the health indicators of a patient is provided. FIG. 3 illustrates the steps of one embodiment of method 300. Referring to FIG. 3, the method 300 can begin at step 305. A patient profile can be stored in step 310. The patient profile can include ranges of different hormone levels, average heart rate, average respiration rate, and the like. The patient profile can also include medical history, those substances to which the patient is allergic, current medication being taken and/or subscribed to the patient, and important timing information, such as the time and date of last medication delivery for a particular substance.

In step 315, a prerecorded message can be stored. The message can be a video and/or audio message that is intended to be played locally or transmitted for review at a remote location. The -prerecorded message can be used to communicate for a user who is unconscious or cannot effectively communicate due to a health condition and/or a disability. The content of the prerecorded message is not limited and can include a message to a health care professional, a message to a friend or relative, and the like.

Health indicators can be detected using one or more sensors at step 320. In operation, the sensors can signal when a particular health indicator is detected. Additionally, in some circumstances, the sensors can also detect the lack of a particular health indicator to notify of a possible malfunction and/or a potential health problem. As discussed previously, sensors can be specifically selected to detect particular health indicators. Since the different health indicators that can be detected are not limited, the health indicators monitored, and therefore detected, can be customized on an individualized patient basis.

In step 325, the detected health indicators can be compared to the patient profile. This step involves analyzing the differences and similarities between the patient profile and the detected health indicators. As one example of the comparing step, the detected heart rate can be compared to the normal range of heart rate as set forth by the patient profile. If the heart rate is outside the normal range, i.e. greater than or less than the normal heart rate, a potential health problem may exist.

In step 330, the programmatic response can be initiated in response to the detected health indicators and/or the comparison of the detected health indicators and the patient profile. The programmatic response can include notifying a health professional, such as a doctor. The health professional can be notified in any suitable manner, such as via a telephone call, a cellular communication, a text message, an electronic mail, a signal to a wireless pager, and the like. While the notification can be simply a message that the patient may be having a health problem, the notification can also provide relevant information, such as the detected conditions, the patient profile, the patient medical history, current medication being taken by and/or prescribed to the patient, and any other relevant information. In a similar fashion, the programmatic response can also include notifying a third party, such as a friend or relative.

Further, the programmatic response can include notifying the patient. The patient can be notified in a similar manner as the manner in which the health professional and the third party can be notified. Nevertheless, the patient can also be notified via a suitable health monitoring device. A suitable health monitoring device can include a viewing screen for displaying the notification, along with any instructions or advice, an auditory structure for producing a notification sound, and/or a simple light emitting structure, such as a light emitting diode, to notify the patient.

Turning to step 335, a computing device can also be signaled when the detected health indicators are outside of the established normal range. The particular computing device which can be signaled is not limited and can include one or more computing devices, such as the patient's personal computing device, a third party computing device, and a health professional computing device. Similar to the notification, the signaling of a computing device can include a simple signal indicating the detection of a health indicator. Further, the signal can include relevant information regarding the detection, such as the detected condition(s), the patient profile, the patient medical history, current medication, and any other relevant information. Providing such information to a computing device can provide a detailed record that can be stored and searched electronically. Additionally, signaling a computing device can also trigger the computing device to notify a health professional, a third party, and the patient as discussed previously.

In step 340, the prerecorded message can be played. As noted previously, the prerecorded message can include audio and/or video and can be played locally or transmitted for review at a remote location. The prerecorded message can be played to communicate for a user who is unconscious or cannot effectively communicate due to a health condition and/or a disability.

Turning to step 345, medical advice can be received. Medical advice can be received from one source or a combination of sources. The medical advice can be received from a health care professional. The health care professional can provide the medical advice based on the notification and/or the signal received by the health professional computing device. Nevertheless, the medical device can also be received from a third party such as a friend and/or relative. While a third party may not be licensed to practice medicine, the third party may be able to simply provide reminders to take a certain medication, to rest, to exercise, and the like. Additionally, medical advice can be received from a computing device that is programmed with suitable software for providing medical advice. Medical advice can also be received from a health monitoring device capable of providing advice.

The medical advice can be received via one or more channels. The medical advice can be received via a telephone call, a video call, a cellular communication, an electronic mail, a text message, a signal to a pager and the like. The sources described above can all be configured to communicate via these channels. Additionally, the medical advice can be received via a health monitoring device. In one example, a wearable and mobile health monitoring device can receive the medical advice and display the medical advice to the patient, enabling the patient to receive medical advice in a mobile environment.

In step 350, substance delivery can be regulated. The regulation of substance delivery can ensure that health indicators are within the established normal range as set forth in the patient profile. The regulation of substance delivery can be accomplished in any suitable arrangement, such as a processor coupled with a medication delivery system. Typically, substance delivery systems include dermal patches and medication pumps and ports; however, the invention is not limited in this regard as any suitable substance delivery system can be used. In such an arrangement, the medication delivery system can be controlled to either increase and/or decrease the delivery of particular substances. As an illustrating example, the medication pump can be signaled to deliver nitrogen to a patient who is experiencing a heart attack. The delivery of nitrogen may help to bring the detected health indicators that are indicative of a heart attack back with the normal range.

In one embodiment, the step of regulating substance delivery can be in conjunction with the step of receiving medical advice. More particularly, receiving medical advice can include receiving a communication from a remote computing system specifying a course of treatment that causes the health monitoring device to signal a medication delivery system thereby regulating the delivery of at least one substance according to the course of treatment.

As an example, the health professional, such as a doctor, can diagnosis a patient's health situation. Based on the diagnosis, the doctor can input the course of treatment into a computing device. This computing device, which is remote relative to the patient, can send a communication specifying a course of treatment via cellular communications. The communication specifying a course of treatment can be received by a health monitoring device used by the patient. According to the course of treatment specified, the health monitoring device can instruct a medication delivery system to regulate the delivery of one or more substances. Accordingly, the medication delivery system can start, stop, increase, or decrease the delivery of the one or more substances. Thus, the patient is provided with remotely initiated, but individually customized, health treatment. In any case, the regulation of a medication delivery system also can occur solely within the health monitoring device responsive to detecting health indicators and comparing those health indicators with a stored patient profile without health care professional and/or third party intervention.

Turning to step 355, the patient profile can be updated according to the detected health indicators. The patient profile can be updated dynamically and in real time as health indicators are detected and/or can be updated periodically. The patient profile can be updated to reflect any changes in the normal range of health indicators for the patient. Method 300 can end at step 360 or can repeat any of the previous steps.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A wearable health monitoring device comprising:
a plurality of sensors configured to monitor health indicators;
at least one sensor interface for receiving health indicator data from said plurality of sensors;
at least one memory for storing the health indicator data; and
a processor for analyzing the health indicator data, wherein said processor is configured to dynamically regulate a substance delivery mechanism responsive to the health indicator data.

2. The monitoring device according to claim 1, wherein said sensors include at least one sensor to monitor heart rate, heart murmur, heart intensity, electro-cardio signals, lung noise, respiration rate, occlusion, adrenal level, acetycholine level, temperature, and sodium levels.

3. The monitoring device according to claim 1, further comprising a wireless transceiver for communicating with at least one of an emergency service, a health care professional, a third party, and a processing device.

4. The monitoring device according to claim 3, wherein the wireless transceiver is configured to detect available communication links.

5. The monitoring device according to claim 1, further comprising a viewing screen for displaying at least one of data from said sensors, data received by said transceiver from a remote source, and device diagnostic information.

6. The monitoring device according to claim 1, wherein said processor is programmed with an individualized patient profile establishing ranges of normal health indicators, wherein said processor compares the health indicator data with the patient profile.

7. The monitoring device according to claim 6, wherein said processor signals said medication delivery system to regulate the delivery of at least one substance.

8. The monitoring device according to claim 7, further comprising a wireless transceiver through which said processor communicates with the medication delivery system.

9. The monitoring device according to claim 8, wherein the medication delivery system is at least one of a dermal patch, a medication port, and a medication pump.

10. The monitoring device according to claim 1, further comprising a wireless transceiver for communicating with an authorized computing system, wherein said processor signals said medication delivery system to regulate delivery of a substance responsive to receiving a medication delivery signal from the authorized computing system.

11. The monitoring device according to claim 10, wherein the medication delivery system is at least one of a dermal patch, a medication port, and a medication pump.

12. A patient health monitoring system comprising:
a wearable patient health monitoring device having a plurality of sensors configured to monitor health indicators, a data storage for recording monitored health indicators as data, a transceiver for wireless communications, a medication delivery system, and a processor configured to dynamically regulate substance delivery to the patient, said processor responding to indicator data;
at least one health professional computing device communicably coupled to said monitoring device via a communications network;
at least one third party computing device communicably coupled to said monitoring device via a communications network.

13. The monitoring system according to claim 12, further comprising a patient computing device communicably coupled to said monitoring device and communicably coupled to said health professional computing device and said third party computing device via at least one of a wired communications network and a wireless communications network.

14. The monitoring system according to claim 12, wherein at least one of said patient computing device and the health monitoring device is configured to play audible messages.

15. The monitoring system according to claim 14, wherein said processor is programmed with an individualized patient profile establishing ranges of normal health indicators such that said processor compares detected health indicators to said range of normal health indicators.

16. The monitoring system according to claim 15, wherein said health monitoring device signals at least one of said patient computing device, said health professional computing device, and said third party computing device when detected health indicators are outside of said range of normal health indicators.

17. The monitoring system according to claim 15, wherein the patient profile is updated based on detected health indicators.

18. The monitoring system according to claim 12, wherein said monitoring device contacts at least one of said health professional computing device and said third party computing device based on data from said sensors.

19. A method for monitoring the health indicators of a patient, comprising the steps of:
storing an individualized patient profile to establish normal ranges of health indicators;
detecting patient health indicators using at least one sensor;
comparing detected health indicators to the patient profile; and
initiating a programmatic response to at least one of said detecting step and said comparing step, wherein said programmatic response is selected from the group consisting of notifying a health professional, notifying the patient, notifying a third party, and regulating the delivery of a substance to the patient.

20. The method according to claim 19, further comprising the step of signaling at least one of a personal computing device, a third party computing device, and health professional computing device when the detected health indicators are outside of the established normal range.

21. The method according to claim 19, further comprising the step of:
storing at least one prerecorded message; and
playing at least one prerecorded message.

22. The method according to claim 19, further comprising the step of receiving a communication from a remote computing system specifying a suggested course of treatment.

23. The method according to claim 22, further comprising the step of signaling a medication delivery system to regulate the delivery of at least one substance according to said suggested course of treatment.

24. The method according to claim 19, further comprising the step of updating the patient profile according to detected health indicators.

25. A machine readable storage, having stored thereon a computer program having a plurality of code sections executable by a machine for causing the machine to perform the steps of:
storing an individualized patient profile to establish normal ranges of health indicators;
detecting patient health indicators using at least one sensor;
comparing detected health indicators to the patient profile; and
initiating a programmatic response to at least one of said detecting step and said comparing step, wherein said programmatic response is selected from the group consisting of notifying a health professional, notifying the patient, notifying a third party, and regulating the delivery of a substance to the patient.

26. The machine readable storage according to claim 25, further causing the machine to perform the step of signaling at least one of a personal computing device, a third party computing device, and health professional computing device when the detected health indicators are outside of the established normal range.

27. The machine readable storage according to claim 25, further causing the machine to perform the steps:
storing at least one prerecorded message; and
playing at least one prerecorded message.

28. The machine readable storage according to claim 25, further causing the machine to perform the step of receiving a communication from a remote computing system specifying a suggested course of treatment.

29. The machine readable storage according to claim 28, further causing the machine to perform the step of signaling a medication delivery system to regulate the delivery of at least one substance according to said suggested course of treatment.

30. The machine readable storage according to claim 25, further causing the machine to perform the step of updating the patient profile according to detected health indicators.
